(19) United States
(12) Patent Application Publication
(10) Pub. No.: US 2006/0241962 A1
(43) Pub. Date: Oct. 26, 2006

(54) Context-driven transaction reports

(76) Inventors: John Reed Flora, Pleasanton, CA (US); Kevin M. Reeth II, San Jose, CA (US); George Albert Hansen, Danville, CA (US); James Robert Del Favero, Redwood City, CA (US); Glynis Hively, Santa Clara, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/266,829

(22) Filed: Nov. 3, 2005

Related U.S. Application Data
(60) Provisional application No. 60/673,660, filed on Apr. 20, 2005.

(51) Int. Cl. G06Q 99/00; G06F 15/02; G06Q 40/00

(52) U.S. Cl. 705/1; 705/9; 705/39

(57) ABSTRACT

Reports are automatically generated based on data currently displayed in a user interface such as a transaction register. The report generation is unobtrusive, allowing the user to continue to work with the current portion of the user interface before, during, and after the report is displayed. The report generation is also context-driven, obtaining parameters used to construct the report from the current user context.

### CROSS-REFERENCE TO RELATED APPLICATION

This application claims priority from U.S. Provisional Application No. 60/673,660 entitled “Mini-Reports in Personal Financial Software,” filed Apr. 20, 2005, the disclosure of which is incorporated herein by reference.

### BACKGROUND

The present invention relates to the display of context-driven reports within a software user interface.

Current software packages, including personal financial software such as Quicken®, have the capability to track large quantities of data. Such data are rarely useful to the user in their raw form, however. Rather, it is the ability to obtain a view of a desired subset of the information, arranged in a way convenient and easily comprehensible to the user, that frequently proves most useful. Thus, most current software packages allow the user to obtain reports displaying user-specified aspects of his or her data by specifying certain report parameters, such as the type of information to be displayed, as well as the time period from which the data should be drawn. Such reports can include, for example, a list of expenditures at certain stores within the last several months, or an average of the ten most recent payments made for dining.

Many users do not know how to properly carry out the process needed to obtain a report; some are not even aware that obtaining a report is possible. Even if one is aware of the existence of reports and knows how to obtain them, the process of specifying the parameters needed to obtain the desired report can be cumbersome. There are many situations in which a quick, automatic view of information related to the user's current activity would prove useful to the user. In the case of a personal financial software program such as Quicken®, for example, where the user enters a list of payments made to particular payees, such situations could include viewing a list of the last 30 days of payments to the particular payee currently selected, or viewing the average payment made to that payee, or viewing a breakdown by payee of the amount spent on a particular category of expenses, such as dining. Some of the benefits conveyed to the user of personal financial software by this type of report include the ability to quickly determine where money is being spent and whether the current payment is out of proportion with respect to previous payments, for example. Unfortunately, the frequency of such situations and the relative difficulty of specifying all the parameters needed for a full report each time, when balanced against the additional information that the report would convey, discourages users from seeking to obtain such reports, despite their usefulness. Thus, in the interests of saving time and minimizing effort, users choose not to seek such reports and in consequence are deprived of much valuable information that could assist them in making better decisions.

It is advantageous to leverage the user's context in formulating report criteria. There is the potential to extract much valuable information about the sort of report in which the user would be interested from contextual information, such as the portion of the application with which he or she is currently interacting, as well as its contents and state. It is advantageous to exploit the user context and propose a report based on it, thus obliging the user to manually specify report parameters.

It is also advantageous to display reports within the context of the user's current activity. It would be more intuitive and less disruptive to the user's current activity if a report could be provided that was unobtrusive and visually tied to the information involved in the current activity. In this way, the user is not required to temporarily abandon his or her current activity and transfer to another part of the application to specify report parameters and separately view the resulting report.

### SUMMARY OF THE INVENTION

Embodiments of the present invention can be implemented in either a personal financial software package or an accounting software package. One skilled in the art will recognize that the present invention could also be implemented in any application that (1) manages data, (2) allows reports on data, and (3) involves displaying the data in a.UI. It can be implemented in different manners, including as a feature of a software package, or as a feature of a web-based application or website, or as a plug-in that can be installed and used in connection with an existing software application.

Embodiments of the present invention allow users to be presented with reports providing further information about the activity at hand within the context of what they are already doing with the program, rather than being obliged to interrupt the current task, transfer control to a separate report-generating form in which the parameters of the desired report are entered, specify the appropriate parameters, and view the report in a context separate from that of their current activity. In addition, embodiments of the present invention provide the report to the user with minimal user intervention.

The present invention is unobtrusive, allowing the user to continue his or her primary work within the user interface without interruption. For example, the invention can be implemented in the context of a transaction register in which the user both enters information associated with a particular payment transaction—such as the name of the payee, the category of the payment (e.g. Dining or Entertainment), and the payment description, date, and amount—and views previously entered transactions. In such a user interface, the user can continue to work directly in the transaction register, while the system displays reports about the transactions at hand in an automatic and unobtrusive manner. Among the events that can cause the system to display such reports are, for example, the user clicking on or mouse-hovering over key portions of the information about the transactions or user interface elements (such as buttons or icons) embedded within or adjacent to such information.

Reports may be displayed in response to various triggers, such as mouse clicks on a report button, or mouse hovering over information of interest. In one embodiment, report contents are tailored to reflect the transaction with which the report is associated and the context in which it is displayed; such tailoring can take a variety of forms, such as adjusting the report fields that are displayed, the type of transactions included, and the range of dates from which the data are drawn. Reports are shown within the context of the user interface, and preferably at a location such that the relationship between the report and the information with which it is associated is readily apparent.

### BRIEF DESCRIPTION OF THE DRAWINGS

FIG. 1 is a block diagram depicting a software architecture for an implementation of the present invention according to one embodiment.

FIGS. 2 and 3 are screen shots that together illustrate the sequence of actions leading up to the display of a report, according to one embodiment of the present invention. FIG. 2 depicts the initial state of the user interface with one active transaction entry. FIG. 3 depicts the user interface after a report associated with the active transaction entry has been displayed.

FIG. 4 is a flowchart depicting a method for displaying a report according to one embodiment.

FIG. 5 is an interaction diagram depicting the sequence of events that takes place when a report is requested according to one embodiment.

FIGS. 6A through 6C are screen shots depicting an embodiment where the user can optionally indicate a budget amount to be displayed within the report.

One skilled in the art will recognize that these Figures are merely examples of the operation of the invention according to one embodiment, and that other user interface arrangements and modes of operation can be used without departing from the essential characteristics of the invention. In particular, the screen shots and user interface elements shown in the Figures are merely exemplary; other layouts, arrangements, formats, and user interface features may be provided without departing from the essential characteristics of the present invention.

### DETAILED DESCRIPTION OF THE EMBODIMENTS

The present invention is now described more fully with reference to the accompanying Figures, in which one embodiment of the invention is shown. The present invention may be embodied in many different forms and should not be construed as limited to the embodiments set forth herein. Rather these embodiments are provided so that this disclosure will be complete and will fully convey principles of the invention to those skilled in the art.

For illustrative purposes, embodiments of the invention are described in connection with the displaying of reports in a personal financial software package. Various specific details are set forth herein and in the Figures, to aid in understanding the present invention. However, such specific details are intended to be illustrative, and are not intended to restrict in any way the scope of the present invention as claimed herein. In particular, one skilled in the art will recognize that the invention can be used in connection with any application involving processing information, where the user can request that the information be summarized in report form and where the information is viewed within a graphical user interface. References herein to such terms as “transaction” and “payee” should thus be taken as merely exemplary, and are not intended to limit the invention to that particular embodiment. In addition, the particular screen layouts, appearance, and terminology as depicted and described herein, are intended to be illustrative and exemplary, and in no way limit the scope of the invention as claimed.

In one embodiment, the present invention is implemented in a conventional personal computer system running an operating system such as Microsoft Windows XP, available from Microsoft Corporation of Redmond, Wash.; MacOS X, available from Apple Computer Inc. of Cupertino, Calif.; or any other operating system designed to generally manage operations on a computing device. In addition, the present invention can be implemented on devices other than desktop personal computers, such as for example personal digital assistants (PDAs), cell phones, computing devices in which one or more computing resources is located remotely and accessed via a network, and the like. The invention may be included as add-on software, or it may be a feature of an application that is bundled with the computer system or sold separately, or it may even be implemented as functionality embedded in hardware.

Output generated by the invention can be displayed on a screen, transmitted to a remote device, stored in a database or other storage mechanism, printed, or used in any other way. In addition, in some embodiments, the invention makes use of input provided to the computer system via input devices such as a keyboard, mouse, touchpad, or the like. Such hardware components, including their operation and interactions with one another and with a central processing unit of the personal computer, are well known in the art of computer systems and therefore are not depicted here. In addition, for embodiments implemented in devices other than personal computers, other types of input and output components may be used, such as touch screens, thumbwheels, stylus-based input, and the like.

In one embodiment, described herein for illustrative purposes, the invention is implemented in a personal financial application in which the application tracks user payment transactions. Such transactions include a payee name (e.g. “Starbucks”), a payment amount (e.g. $7.30), a payment date (e.g. Aug. 22, 2005), and a payment category (e.g. “Food:Out”). Such an application displays the user's transactions in an interactive scrollable chronological list, a region of the user interface known as the transaction register. The user may select and further edit individual transactions within the transaction register, and can enter new transactions in the register, as well. It is appreciated that such an embodiment is merely exemplary, and the present invention, far from being limited to use in such a personal financial application, can be used to enhance the reporting capabilities of applications in a multitude of domains.

User Requests for Reports

Reports may be displayed in response to various triggers. In one embodiment of the invention, a data entry field for entering transactions—such as that found in a transaction register—is augmented with a button or icon which, when pressed, automatically displays a report containing entries that are related to the associated transaction. In the context of other tasks, a report can be displayed in response to the user hovering the mouse cursor over the information of interest, such as the name of the category or payee.

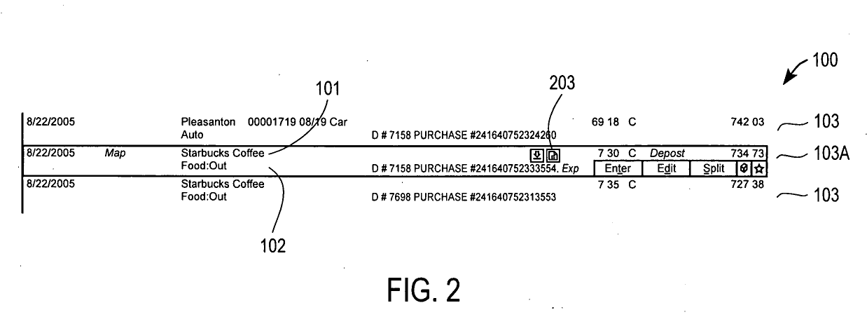

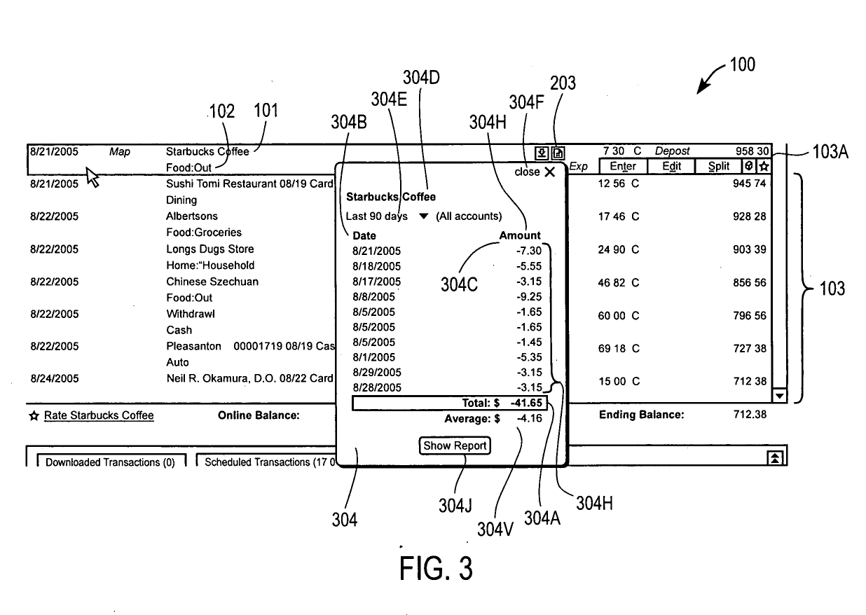

Referring now to FIGS. 2 and 3, there is shown a series of screen shots depicting an example of the present invention. FIG. 2 depicts a portion of a transaction register 100, which is the main transaction entry area for a personal financial application. Here, the user of a personal financial application has entered (or caused to be downloaded) various transaction entries 103, including one transaction entry 103A for $7.30 to Starbucks on Aug. 22, 2005, listed as being in the “Food:Cut” category. Transaction register 100 displays transaction entries 103 in a scrollable chronological list, as in FIG. 2. In transaction entry 103, Payee field 101 contains the text “Starbucks” and Category field 102 contains the text “Food:Out”. In one embodiment of the invention, responsive to a mouse click in payee field 101 of transaction 103A, transaction 103A is designated as active (or selected), as indicated by a black border around transaction 103. Report icon 203 is displayed within or adjacent to payee field 101. In one embodiment, report icon 203 is shown within the currently selected field (such as payee field 101 or category field 102).

Clicking on icon 203 causes a report 304 relevant to the current transaction to be displayed. For example, in FIG. 2, clicking on icon 203 causes a report 304 showing recent Starbucks transactions to be displayed, as in FIG. 3. Alternatively, user 603 could have selected the category field 202—“Food:Out”—for that same transaction entry, and then the report button 203 would have been associated with that particular category, instead of the payee. Alternatively, such reports 204 are displayed responsive to user 603 causing the mouse cursor to hover over payee field 101 or category field 102.

Report Contents

Referring again to FIG. 3, there is shown a screenshot depicting a user interface after user 603 has activated report icon 203. In this particular embodiment, the resulting report 304 is displayed in a window with its upper-right corner anchored to report icon 203 that caused the report to be displayed; this visually reinforces the connection between report 304 and transaction entry 103A upon which it is based. Report 304 includes title 304D stating what category or payee the report is tied to (i.e. the payee “Starbucks,” in this example), report type 304E indicating which subset of information is being displayed (i.e. the last 30 days' worth of transaction entries), date column label 304B and amount column label 304C identifying the type of information displayed below; and transaction entries 304H that match the given criteria of report 304 (i.e. the transaction entries for Starbucks within the last 30 days). Report 304 also contains show report button 304J linking to a more detailed report, report total 304A that contains the sum of the transaction entries for the “Amount” column, average amount 304V, and close box 304F that enables the user to dismiss report 304 whenever he or she has finished examining its information. In an alternative embodiment, other options (such as printing the report) are also provided.

In one embodiment, the contents of report 304 are automatically selected based upon the transaction entry 103A with which it is associated and the context in which report 304 is displayed. Thus, the automatic reports of the present invention are likely to be more relevant to the user in view of his or her current activity.

In one embodiment, report 304 contains a series of transactions 304H accompanied by headings 304B and 304C, subtotal 304A, and/or average 304V. Among the parameters of the report that might be varied are the type of transactions included (e.g. those for a particular payee or for a general category, such as “Food:Out”); the temporal or sequential restrictions on the transactions that are displayed (e.g. between which dates the transactions are displayed, or how many transactions starting from which date); whether or not report 304 provides a means for requesting a more detailed report; the format of report 304 (including whether and how to group, sequence, and display transactions, subtotals, averages, and the like); and the manner in which report 304 is dismissed (e.g. manually via clicking on close box 304F or moving the cursor out of both report 304 and the associated transaction entry 103A, or automatically via a time delay).

For example, one report 304 could be created by clicking on report button 203 associated with category field 102 containing the name of a category for which there are numerous transaction entries. Such a report 304 might, as illustrated in FIG. 3, include all transactions for a particular category within the last 30 days from the current date (including a subtotal summing the value of all the transactions), with a button 204J of getting a more detailed report, and dismissible by the user clicking on close box 304F. Another possible report 304 might include a single entry displaying the average amount of the last ten transactions for a given payee or category, without a means of getting a more detailed report, and being dismissed automatically after a period of several seconds.

In some embodiments, these parameters might not be fixed but instead might vary according to the context in which report 304 was activated. For example, one type of report 304 might be designed to show transactions for the last 30 days if such transactions were sufficiently frequent, but would instead show the last six transactions—even if they occurred more than 30 days before—if the transactions were relatively infrequent. Other embodiments might allow some or all of the parameters to be controlled by the user. For example, one embodiment might allow the user to specify, via a preferences file, the number of transactions, or the number of days of transactions, to be displayed in subsequent reports 304.

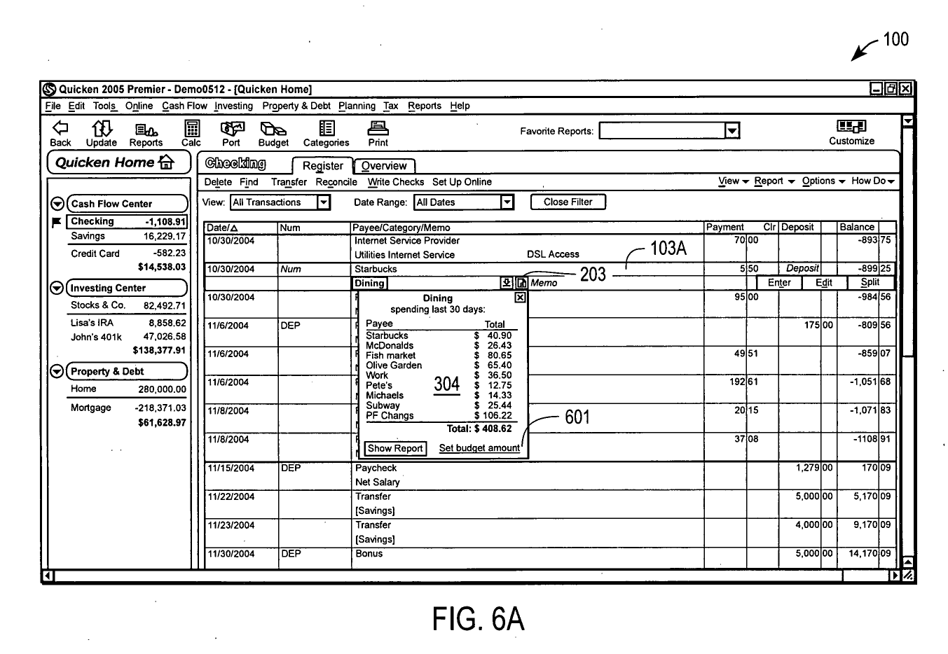

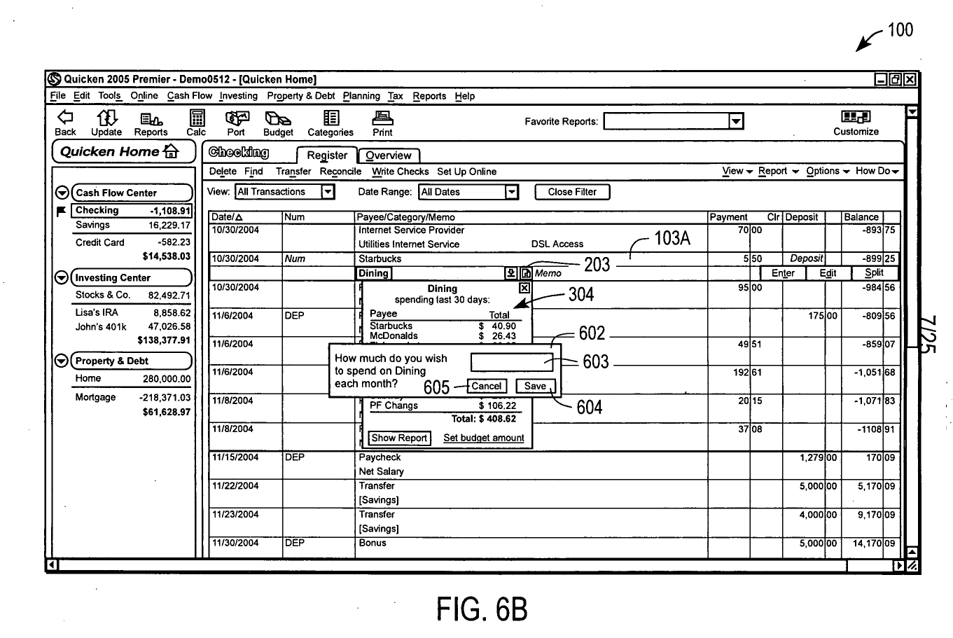

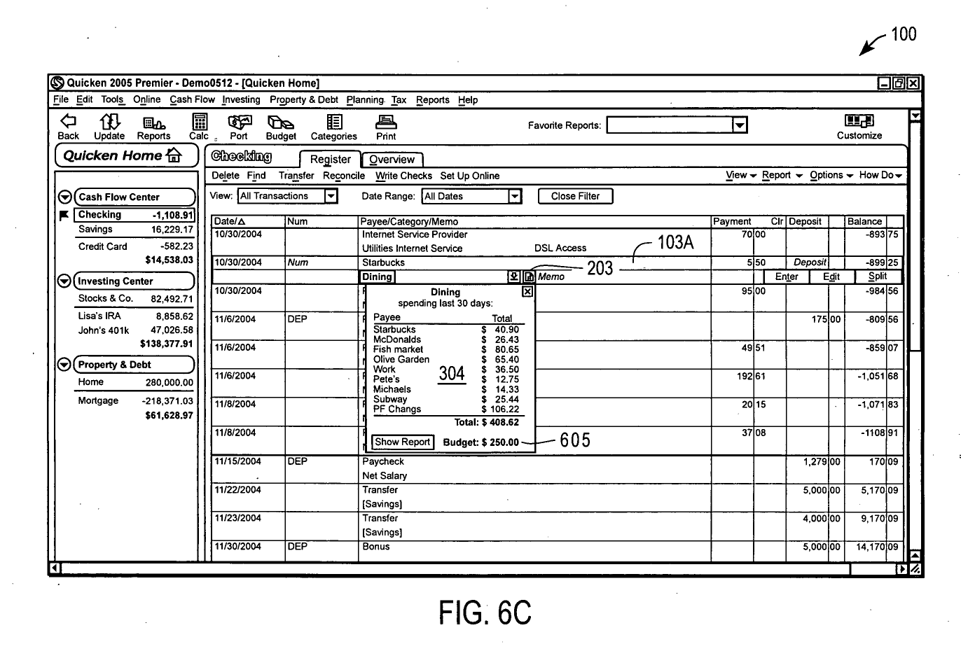

In one embodiment, user 603 can specify a budget amount for a category or payee, and the budget amount can be stored and subsequently displayed when a report 304 associated with that category or payee is displayed. Referring now to FIGS. 6A through 6C, there is shown an example of an embodiment where the user can optionally indicate a budget amount to be displayed within the report.

In FIG. 6A, report 304 is displayed within the context of transaction register 100, showing dining transactions over the last 30 days. Such a report 304 would be displayed, for example, in response to user 603 clicking on report icon 203 within transaction 103A. Report 304 includes Set Budget Amount link 601, which provides user 603 with access to functionality for specifying a budget amount for the dining category.

In FIG. 6B, user 603 has clicked on Set Budget Amount link 601, causing budget dialog box 602 to be displayed. User 603 can enter a budget amount in budget field 603, and can click on save button 604 to save the budget amount or cancel button 605 to dismiss budget dialog box 602 without saving the entered amount. Clicking on save button 604 causes the entered budget amount to be saved, for example within the file associated with the financial transaction data for user 603.

In one embodiment, on subsequent display of report 304 for dining transactions, whether during the current session or later sessions, budget amount 605 is displayed, as shown in FIG. 6C. In order to display such information in later sessions, the present invention searches for stored budget amounts that apply to the payee or category being displayed, when presenting report 304. If any budget amount is found, it is displayed as shown in FIG. 6C.

In one embodiment, user 603 can click on displayed budget amount 605 to reactivate budget dialog box 602 and thereby modify or delete the entered budget amount.

Report Location

In one embodiment, reports 304 are displayed within the context of the user interface, and the relationship between report 304 and the transaction entry 103A with which it is associated is made readily apparent. In an embodiment in which the report is displayed responsive to a user clicking on report icon 203 situated within transaction entry 103A, for example, the report's 304 top-right corner can be anchored to report icon 203, as in FIG. 3. Alternatively, in an embodiment in which report 304 is displayed responsive to mouse hovering over the graphical display of transaction entry 103A, report 304 can be located at the current mouse location, at least partially overlaid on transaction entry 103A.

In all of the foregoing, it is appreciated that such embodiments are stated only for the purpose of example, and that other embodiments could equally be provided without departing from the essential characteristics of the present invention.

System Architecture

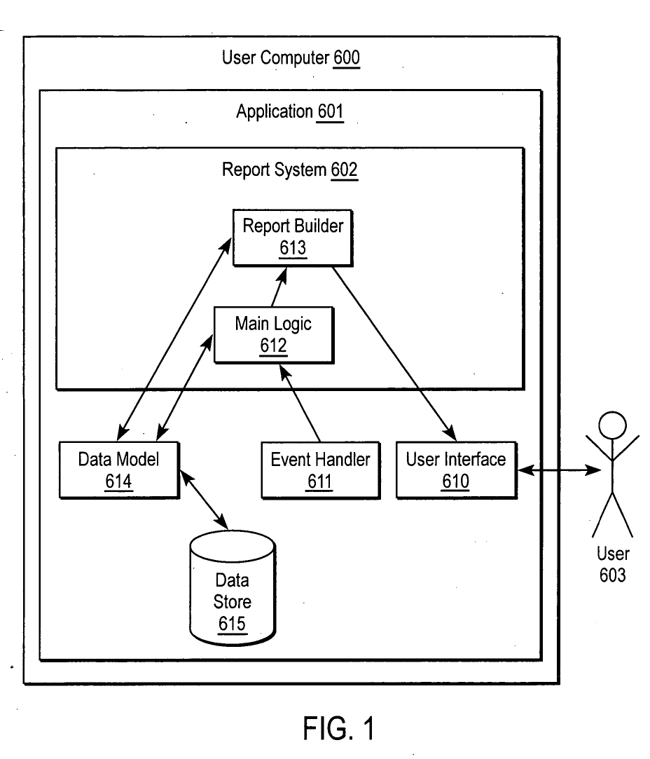

Referring now to FIG. 1, there is shown a system diagram illustrating a software architecture according to one embodiment of the invention. User 603 interacts with user computer 600. User computer 600 is of conventional design, and includes a processor, an addressable memory, and other conventional features (not illustrated) such as a display, local memory, input/output ports, and a network interface. In other embodiments one or more of the components of user computer 600 may be located remotely and accessed via a network (not shown). In various embodiments, user computer 600 may be implemented on a computer running the Microsoft Windows XP operating system, Mac OS, various flavors of Linux, UNIX, Palm OS, and/or other operating systems.

User computer 600 includes a software application 601 and data store 615. Software application 601 includes a number of executable code portions and data files. These include code, for creating and supporting a user interface 610 according to one embodiment of the present invention, as well as for generating context-driven transaction reports according to techniques described herein. In some embodiments, software application 601 is part of a personal financial software package or accounting package; in other embodiments, software application 601 can also be implemented as a standalone application outside of a personal financial software package or accounting package.

Software application 601 is responsible for orchestrating the processes performed according to the methods of the present invention. Software application 601 includes report system 602, which in turn includes report builder 613 and main logic 612, according to one embodiment of the present invention.

Report system 602, report builder 613, and main logic 612 need not be discrete software modules. The software configuration of FIG. 1 is shown for illustrative purposes only; other configurations are contemplated by and within the scope of the present invention.

Software application 601 may be provided to user computer 600 on a computer readable media, such as a CD-ROM, diskette, or by electronic communication over a network. Alternatively, software application 601 and data store 615 can be hosted on a server computer, and accessed over a network, using for example a browser interface to software application 601.

Data store 615 may be a relational database or any other type of database that stores the data used by software application 601, for example account information in the financial management application embodiment referenced above. Data store 615 may be accessible by software application 601 through user interface 610. Software application 601 and data store 615 may be stored and operated on a single computer or on separate computer systems communicating with each other through a network.

One skilled in the art will recognize that the system architecture illustrated in FIG. 1 is merely exemplary, and that the invention may be practiced and implemented using many other architectures and environments.

Data store 615 includes data created by the user 603 and the application program 601. Report system 602 comprises the various components that operate together to implement the invention. Application program 601 includes user interface 610, event handler 611, and data model 614; report system 602 includes main logic 612 and report builder 613.

User interface 610 displays report information on the user's screen and provides a means for the user to interact with report system 602. For example, UI 610 can include standard mechanisms such as a user-controlled cursor, keyboard input, and the like. Event handler 611 detects user interaction with the system and notifies the other components of such events. Main logic 612 orchestrates report generation and presentation operations, including requesting data from, and giving data to, other components of report system 602. Report builder 613 accepts as input the parameters specifying what data should be included in report 304, and then obtains the relevant transaction data from data model 614. Based on these parameters and data, report builder 613 creates report 304 for display. Data model 614 retrieves the underlying transaction data from data store 615 and provides it to other components, such as report builder 613, when requested. The system of FIG. 6 represents one possible implementation of a report system according to the present invention; other embodiments, such as one in which the elements of the invention exist on a computer other than that of the user, or one with different components and/or organizations of components, are equally possible and will be apparent to one of skill in the art.

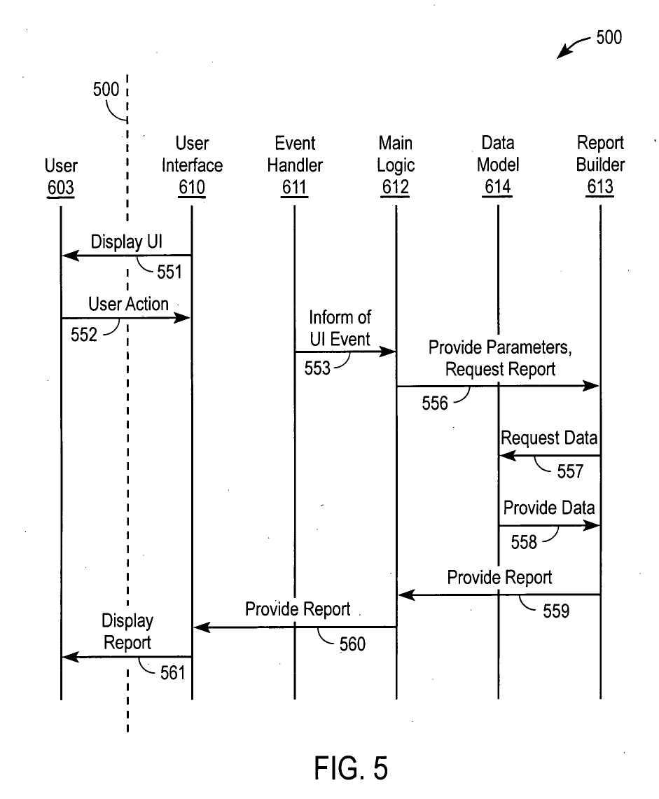

FIG. 5 is an interaction diagram illustrating interactions among system components according to one embodiment. User-system boundary 500 represents the division between the user of the system on the left and the components of the system on the right.

User interface 610 displays 551 the appropriate interface to the user. User 603 takes an action 552 which is interpreted by user interface 610. Any number of interactions between user 603 and user interface 610 may occur before report 304 is ultimately generated. For example, in one embodiment user interface 610 initially displays the set of all transaction entries 103, and the user might click on.“payee” field 101 of one of them. In response, the system redraws the display so as to provide a user interface with a button 203 requesting a report 304 associated with payee field 101 upon which the user had just clicked. Then the user might click on button 203, leading the system to begin displaying report 304.

When the user performs an action causing a report 304 to be displayed, event handler 611 informs 553 the system's main logic 612 of the occurrence of the user interface event. Main logic 612 determines appropriate report parameters based on the user interface event, and then sends a request 556 to report builder 613 for report 304; in one embodiment request 556 includes the appropriate report parameters. Report builder 613 requests 557 any needed report data—such as the transaction data for the date range listed in the report parameters—from data model 614. Data model 614 retrieves the requested information from data store 615 and provides it 558 to report builder 613. Based on this data and the parameters provided with the report request, report builder 613 creates report 304 and provides it 559 to main logic 612. Finally, main logic 612 sends a request 560 to user interface 610 to display the report to user 603, which it then does 561.

For example, user 603 of a personal financial application 601 implementing the report system of the current invention might have input (or might have caused to be downloaded) various transaction entries 103, including one transaction entry 103A of $7.30 to Starbucks on Aug. 22, 2005, listed as being in the “Food:Out” category. User interface 610 shows all (or a subset of) transaction entries 103 in a scrollable list in transaction register 100. User 603 clicks (selects) payee field 101 in transaction entry 103A in register 100, causing transaction entry 103A to become active and causing report icon 203 to appear. The user clicks 552 report icon 203 to request report 304 for the payee “Starbucks.” Event handler 611 notifies 553 main logic 612 of the button click, at which point main logic 612 notes that the report type is for a payee, for the particular payee “Starbucks”, and that the date range should be the last 30 days. Main logic 612 requests 556 that report builder 613 generate a report corresponding to those parameters. Report builder 613 requests 557 transaction data for Starbucks for the last 30 days from data model 614. After data model 614 provides 558 the requested data, report builder 613 generates report 304 based on that data and the given parameters and provides it 559 to main logic 612. Resulting report 304 lists the last 30 days of Starbucks purchases 304H, total value of those purchases 304A, show report button 304J leading to a more detailed report, and close box 304F for manually dismissing the report. Finally, main logic 612 supplies 560 report 304 to user interface 610, which in turn displays 561 the report to user 603.

In one embodiment, clicking on show report button 304J launches a corresponding full report. When the user clicks on show report button 304J, report 304 is dismissed and a full report launched. The existing filter is first copied and then modified as required. The filter is then passed to launch the full report.

It is apparent that the conceptual components of FIGS. 5 and 6 and their relationships represent but one possible means of implementing the invention. One skilled in the art will recognize that other arrangements and combinations of components can also be used to implement the present invention, without departing from the essential characteristics of the invention.

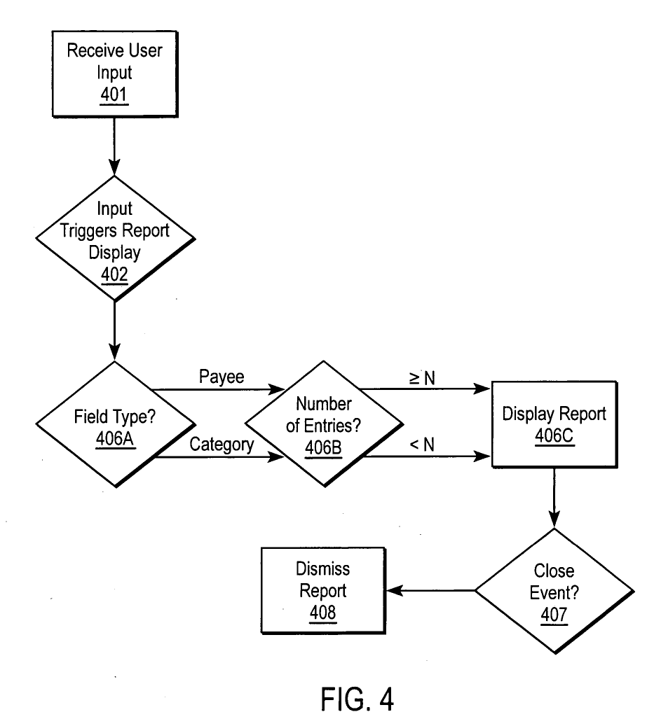

Referring now to FIG. 4, there is shown a flowchart depicting a method for displaying report 304 responsive to user actions and within the context of user interface 610. In the course of user interaction with software application 601, application 601 receives user input 401. Application 601 determines 402 whether or not the user input triggers the displaying of a report 304. Any type of user action might constitute such triggering event: for example, a mouse click, mouse hovering, keyboard focus and selection, or a variety of other input techniques well known to those of skill in the art of designing user interfaces.

At step 402, if the user input does trigger the displaying of a report 304, then a determination is made 406A as to which type of data should form the basis of the report, e.g. the “payee” or “category” type of the above “Starbucks” example. A determination is then made 406B as to whether the number of transaction entries 103 for that data within some desired date interval (for example, the past 30 days) exceeds a certain threshold and produces the appropriate output accordingly. (For example, in one embodiment, if there are relatively few transaction entries within the past 30 days, report 304 can include the last N transaction entries regardless of date). Based upon the information determined in steps 406A and 406B, report 304 is displayed 406C. After report 304 is displayed 406C, a close event 407 for report 304 (triggered, for example, by activation of close box 304F, or after some set period of time has elapsed) causes report 304 to be dismissed 408. The report close event 407 need not occur before the user continues to use the rest of the application; the report window might be made modeless, for example. It is appreciated that in the foregoing, the specifics are arbitrary design decisions for which a range of choices are appropriate.

Software Method

In one embodiment, calls to report builder 613 take the following form. The caller (such as a software application or component of application 601) creates the specific type of MiniReportBuilder to create the report 304. The caller also creates the specific type of MiniReport, sets it up, and hands it to report builder 613. Then the caller asks report builder 613 to create the report. Report builder 613 parses the results and sets them directly into report 304 being generated.

An example of the steps to perform such an operation is as follows:

Create MiniReport Object.

Ask MiniReport to set itself up. This includes creating its Report Filter and DateRange, setting its subtotal rules, setting its column headers, and the like.

Create MiniReportBuilder Object.

Hand MiniReport to report builder 613.

Tell report builder 613 to build report.

Ask report builder 614 to finish creating the report. This includes adding header, total, average (as appropriate), show report button (as appropriate), and the like.

Display report 304 via user interface 610.

### EXAMPLES

The following are examples of reports 304 that can be generated according to one embodiment, along with a sample Build Request for each.

Category Control Spending Report

For all accounts, find all transactions in the last 30 days where category=XYZ. Group and sub-total results by payee.

Build Request:

```
Type = Category Control Spending
Filter
    Create with Include All
    Exclude all Categories
    Include the Category for the transaction
Date Range:
    Set Start Date to today-30 days
    Set End date to today
Set Currency to the one of the account
Set Sub-Group Totals for:
    By Payee
```

Payee Control Spending Report

For all accounts, find all transactions in the last 30 days where payee=XYZ. Group and sub-total results by day.

Build Request:

```
Type = Payee Control Spending
Filter
    Create with Include All
    Exclude all Payees
    Include the Payee for the transaction
Date Range:
    Set Start Date to today-3 years
    Set End date to today
Set Currency to the one of the account
Set Sub-Group Totals for:
    By Day
```

Payee Ensure Bill Accuracy Report

For all accounts, find the last 6 transactions plus the 1 transaction last year where payee=XYZ and transaction date is <3 years. Return the individual transaction.

Build Request:

```
Type = Payee Ensure Bill Accuracy
Filter
    Create with Include All
    Exclude all Payees
    Include the Payee for the transaction
Date Range:
    Set Start Date to today-3 years
    Set End date to today
Set Currency to the one of the account
Set Sub-Group Totals for:
    By Transaction
Special: Terminate after 6 + 1 year ago transactions
```

Split-Transaction Report

For all accounts, find all transactions in the last 30 days for each category found in the split transaction. Group/subtotal by category.

Build Request:

```
Type = Category Control Spending
Filter
    Create with Include All
    Exclude all Categories
    Include each and every Category for the transaction
Date Range:
    Set Start Date to today-30 days
    Set End date to today
Set Currency to the one of the account
Set Sub-Group Total Type:
    By Category
```

In one embodiment, report 304 can be a graphical report and is not limited to text-based data.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for displaying a report, comprising:
displaying a user interface for displaying a plurality of transaction entries;
receiving user input associated with at least one of the transaction entries;
responsive to the user input, and responsive to at least one attribute of the associated transaction, selecting a report type and determining at least one report parameter;
generating a report of the selected type, according to the at least one determined report parameter; and
displaying the generated report within the context of the user interface displaying the plurality of transaction entries.

2. The method of claim 1, wherein displaying the report comprises overlaying the report on the user interface.

3. The method of claim 1, wherein displaying the report comprises displaying the report in a location that at least partially overlaps the user interface displaying the plurality of transaction entries.

4. The method of claim 1, wherein the user interface displaying the plurality of transaction entries comprises a transaction register.

5. The method of claim 1, wherein the user interface displaying the plurality of transaction entries comprises a transaction register of a personal financial software application.

6. The method of claim 1, wherein the user interface displaying the plurality of transaction entries comprises a transaction register of an accounting software application.

7. The method of claim 1, wherein each transaction entry comprises a numeric value.

8. The method of claim 7, wherein each transaction entry comprises a monetary amount.

9. The method of claim 7, wherein the generated report comprises an average of the numeric values for transaction entries associated with the report.

10. The method of claim 7, wherein the generated report comprises a sum of the numeric values for transaction entries associated with the report.

11. The method of claim 1, wherein generating a report comprises generating a report comprising transaction entries that satisfy a given selection criterion.

12. The method of claim 1, wherein generating a report comprises generating a report comprising transaction entries having dates that fall within a predefined date range.

13. The method of claim 1, wherein generating a report comprises generating a report comprising a number of transaction entries not exceeding a predefined maximum.

14. The method of claim 1, wherein generating a report comprises generating a report comprising a number of transaction entries having a field value matching a predefined value.

15. The method of claim 14, where the field value comprises a category.

16. The method of claim 14, where the field value comprises a payee.

17. The method of claim 1, wherein displaying the generated report comprises displaying the report at a location anchored to a portion of the user interface associated with the transaction entry associated with the user input.

18. The method of claim 1, wherein receiving user input comprises detecting user activation of an on-screen user interface element associated with generating reports.

19. The method of claim 1, further comprising, responsive to user input associated with a portion of the generated report, displaying a more detailed report describing an information item located at the portion associated with the user input.

20. The method of claim 1, wherein the displayed report is modeless.

21. The method of claim 1, wherein the displayed report comprises a budget amount corresponding to the at least one report parameter.

22. The method of claim 1, further comprising:
receiving user input indicating a budget amount corresponding to the at least one report parameter; and
storing the budget amount.

23. A computer program product for displaying a report, comprising:
a computer-readable medium; and
computer program code, encoded on the medium, for:
displaying a user interface for displaying a plurality of transaction entries;
receiving user input associated with at least one of the transaction entries;
responsive to the user input, and responsive to at least one attribute of the associated transaction, selecting a report type and determining at least one report parameter;
generating a report of the selected type, according to the at least one determined report parameter; and
displaying the generated report within the context of the user interface displaying the plurality of transaction entries.

24. The computer program product of claim 23, wherein the computer program code for displaying the report comprises computer program code for overlaying the report on the user interface.

25. The computer program product of claim 23, wherein the computer program code for displaying the report comprises computer program code for displaying the report in a location that at least partially overlaps the user interface displaying the plurality of transaction entries.

26. The computer program product of claim 23, wherein the user interface displaying the plurality of transaction entries comprises a transaction register.

27. The computer program product of claim 23, wherein the user interface displaying the plurality of transaction entries comprises a transaction register of a personal financial software application.

28. The computer program product of claim 23, wherein the user interface displaying the plurality of transaction entries comprises a transaction register of an accounting software application.

29. The computer program product of claim 23, wherein each transaction entry comprises a numeric value.

30. The computer program product of claim 29, wherein each transaction entry comprises a monetary amount.

31. The computer program product of claim 29, wherein the generated report comprises an average of the numeric values for transaction entries associated with the report.

32. The computer program product of claim 29, wherein the generated report comprises a sum of the numeric values for transaction entries associated with the report.

33. The computer program product of claim 23, wherein the computer program code for generating a report comprises computer program code for generating a report comprising transaction entries that satisfy a given selection criterion.

34. The computer program product of claim 23, wherein the computer program code for generating a report comprises computer program code for generating a report comprising transaction entries having dates that fall within a predefined date range.

35. The computer program product of claim 23, wherein the computer program code for generating a report comprises computer program code for generating a report comprising a number of transaction entries not exceeding a predefined maximum.

36. The computer program product of claim 23, wherein the computer program code for generating a report comprises computer program code for generating a report comprising a number of transaction entries having a field value matching a predefined value.

37. The computer program product of claim 26, where the field value comprises a category.

38. The computer program product of claim 26, where the field value comprises a payee.

39. The computer program product of claim 23, wherein the computer program code for displaying the generated report comprises computer program code for displaying the report at a location anchored to a portion of the user interface associated with the transaction entry associated with the user input.

40. The computer program product of claim 23, wherein the computer program code for receiving user input comprises computer program code for detecting user activation of an on-screen user interface element associated with generating reports.

41. The computer program product of claim 23, further comprising, computer program code for, responsive to user input associated with a portion of the generated report, displaying a more detailed report describing an information item located at the portion associated with the user input.

42. The computer program product of claim 23, wherein the displayed report is modeless.

43. The computer program product of claim 23, wherein the displayed report comprises a budget amount corresponding to the at least one report parameter.

44. The computer program product of claim 23, further comprising computer program code for:
receiving user input indicating a budget amount corresponding to the at least one report parameter; and
storing the budget amount.

45. A system for displaying a report, comprising:
a display device, for displaying a user interface for displaying a plurality of transaction entries;
an input device, for receiving user input associated with at least one of the transaction entries; and
a processor for:
responsive to the user input, and responsive to at least one attribute of the associated transaction, selecting a report type and determining at least one report parameter; and
generating a report of the selected type, according to the at least one determined report parameter;
wherein the display device displays the generated report within the context of the user interface displaying the plurality of transaction entries.
